(19) United States
(12) Patent Application Publication
(10) Pub. No.: US 2025/0059354 A1
(43) Pub. Date: Feb. 20, 2025

(54) RECYCLABLE COMPOSITES OF VARYING AND HYBRID REINFORCEMENT MATERIALS

(71) Applicant: Alliance for Sustainable Energy, LLC, Golden, CO (US)

(72) Inventors: Nicholas A. RORRER, Golden, CO (US); Erik Glenn ROGNERUD, Parker, CO (US)

(21) Appl. No.: 18/805,961

(22) Filed: Aug. 15, 2024

Related U.S. Application Data
(60) Provisional application No. 63/519,646, filed on Aug. 15, 2023.
(60) Provisional application No. 63/573,604, filed on Apr. 3, 2024.

(51) Int. Cl. C08K 7/06

(52) U.S. Cl. CPC C08K 7/06

(57) ABSTRACT

The present disclosure relates to a composition that includes a matrix material constructed of at least one of a polyester resin, a polyester polymer, and/or a combination thereof and a plurality of fibers, where the plurality of fibers includes a first portion of an inorganic fiber and a second portion of an organic fiber, and the plurality of fibers and the matrix material are in physical contact.

### CROSS-REFERENCE TO RELATED APPLICATIONS

This application claims priority from U.S. Provisional Patent Application Nos. 63/519,646 and 63/573,604 filed on Aug. 15, 2023 and Apr. 4, 2024, respectively, the contents of which are incorporated herein by reference in their entirety.

### CONTRACTUAL ORIGIN

This invention was made with government support under Contract No. DE-AC36-08GO28308 awarded by the Department of Energy. The government has certain rights in the invention.

### BACKGROUND

Modern composites offer enhanced performance at a fraction of the weight when compared to metal materials. However, these materials suffer from a variety of issues. For example, they are often non-recyclable, brittle, and expensive. Thus, there remains a need for new materials and methods for making fiber composite layers having more tunable physical properties and performance metrics, while also being economical at the manufacturing scale and meeting today's needs for circularity.

### SUMMARY

An aspect of the present disclosure is a composition that includes a matrix material constructed of at least one of a polyester resin, a polyester polymer, and/or a combination thereof and a plurality of fibers, where the plurality of fibers includes a first portion of an inorganic fiber and a second portion of an organic fiber, and the plurality of fibers and the matrix material are in physical contact.

In some embodiments of the present disclosure, the matrix material may be derived from reacting an anhydride with an epoxy. In some embodiments of the present disclosure, the anhydride may include at least one of methylhexahydrophthalic anhydride (MHHPA), glutaric anhydride (GA), and/or a combination thereof. In some embodiments of the present disclosure, the epoxy may include at least one of 1,4-butanediol-diglycidly ether (BDODGE), sorbitol polyglycidyl ether (SPGE), poly(ethylene glycol) diglycidyl ether (PEGDGE), and/or a combination thereof. In some embodiments of the present disclosure, the matrix material may be a thermoset.

In some embodiments of the present disclosure, the inorganic fiber may include at least one of glass, carbon, basalt, and/or a combination thereof. In some embodiments of the present disclosure, the organic fiber may include at least one of polypropylene (PP), polyethylene (PE), polyethylene terephthalate (PET), polyether ether ketone (PEEK), a polyaramid, polyparaphenylene terephthalamide, and/or a combination thereof. In some embodiments of the present disclosure, the fibers may be chopped. In some embodiments of the present disclosure, the fibers may be at least one of woven, unidirectional, and/or a combination thereof.

In some embodiments of the present disclosure, the matrix material and the plurality of fibers may be positioned to form an interlaminate hybrid composite that includes a first ply and a second ply. In some embodiments of the present disclosure, the first ply may include the first portion of the plurality of fibers and the second ply may include the second portion of the plurality of fibers. In some embodiments of the present disclosure, the first portion may contain carbon fibers and the second portion may contain PE fibers. In some embodiments of the present disclosure, the composition may include at least two plies of carbon fibers and two plies of PE fibers. In some embodiments of the present disclosure, the plies of carbon fibers and the plies of PE fibers may alternate.

In some embodiments of the present disclosure, the matrix material and the plurality of fibers may be positioned to form an interwoven hybrid composite comprising a ply. In some embodiments of the present disclosure, the ply may include interwoven fibers of the first portion and the second portion of the plurality of fibers. In some embodiments of the present disclosure, the first portion may contain carbon fibers and the second portion may contain PE fibers.

In some embodiments of the present disclosure, the composition includes a matrix material constructed of a polyester thermoset, the first portion and the second portion form a first ply of interwoven organic fibers and inorganic fibers, the first portion forms a second ply of woven inorganic fibers, the organic fibers are constructed of polyethylene, and the inorganic fibers are constructed of carbon fiber.

In some embodiments of the present disclosure, the composition includes a matrix material constructed of a polyester thermoset, the first portion and the second portion form a ply of interwoven organic fibers and inorganic fibers, the organic fibers are constructed of polyethylene, and the inorganic fibers are constructed of carbon fiber.

An aspect of the present disclosure is a method that includes immersing in methanol a first generation composite constructed of a matrix material constructed of a polyester thermoset and a plurality of fibers, where the plurality of fibers include a first portion of an inorganic fiber and a second portion of an organic fiber, the plurality of fibers and the matrix material are in physical contact, the immersing results in the deconstruction of matrix material and the forming of a mixture that includes a liquid phase and a solid phase, the liquid phase includes methanol and deconstruction products, and the solid phase includes at least one of the organic fiber, the inorganic fiber, and/or a combination thereof.

### BRIEF DESCRIPTION OF DRAWINGS

Some embodiments are illustrated in referenced figures of the drawings. It is intended that the embodiments and figures disclosed herein are to be considered illustrative rather than limiting.

FIG. 1 illustrates a composite, according to some embodiments of the present disclosure. (Not drawn to scale.)

FIG. 2A illustrates reactions for producing polyester thermosetting polymers and/or resins to be used as matrices in composites, according to some embodiments of the present disclosure.

FIG. 2B summarizes several formulations of polyester thermosets, some of which were used as matrices in composites synthesized via the chemistry illustrated in FIG. 2A, according to some embodiments of the present disclosure.

FIG. 2C a structure corresponding to polyester thermoset resulting from Formulation F1 (see Table 1), according to some embodiments of the present disclosure.

FIG. 3 illustrates different types of hybrid composites, according to some embodiments of the present disclosure. These are “interlaminate” (Panel A), “interwoven” (Panel B), and “interspersed” (Panel C). CF=carbon fiber; PE=polyethylene fiber.

FIG. 4 illustrates a system for producing a composite, according to some embodiments of the present disclosure.

FIG. 5A illustrates photographs of different materials constructing fibers that may be used in composites as described herein, include a group used in traditional reinforcements (carbon, glass, Kevlar, etc.) and a group using thermoplastics to produce fibers used in composites, according to some embodiments of the present disclosure. (The matrix used in each composite was synthesized according to Formulation F1 in the table illustrated in FIG. 2B.) Each composite was constructed using a 1:1 weight ratio of matrix to fiber.

FIG. 5B compares the effects of the different fiber-containing composites illustrated in FIG. 5A on greenhouse gas (GHG) emissions, cost, density, and lightweighting, according to some embodiments of the present disclosure. Panel A corresponds to composites constructed using traditional reinforcements and Panel B to composites constructed using thermoplastic reinforcements. (The matrix used in each composite was synthesized according to Formulation F1 in the table illustrated in FIG. 2B.) Each composite was constructed using a 1:1 weight ratio of matrix to fiber.

FIG. 5C summarizes parameters and physical properties of the composite materials illustrated in FIG. 5A, according to some embodiments of the present disclosure.

FIG. 6 illustrates iso-stress curves at two temperatures (Panel A at 35° C. and Panel B at 160° C.) of composites containing different amounts and orientations of polyethylene fibers combined with carbon fibers, these then combined with a polyester thermoset (a matrix material) to make different composites, according to some embodiments of the present disclosure. HC-8 is a composite (not a hybrid composite) made of five plies of a single fiber material (carbon fiber). HC-7 is a laminate interwoven hybrid composite and HC-2 is an interlaminate woven/interwoven composite (matrix synthesized according to Formulation F1 in the table illustrated in FIG. 2B.)

FIG. 7 illustrates plots of flexural strength versus flexural strain obtained for two hybrid composites, according to some embodiments of the present disclosure. (CFRC=carbon fiber reinforced composite; PE/CFRC=polyethylene/carbon fiber reinforced composite; Formulation F1)

FIG. 8 illustrates empirical properties of neat polymer (a matrix material), and polymer impregnated composites of different fiber composition, according to some embodiments of the present disclosure. (Matrix synthesized according to Formulation F1 in the table illustrated in FIG. 2B.)

FIG. 9 illustrates iso-stress curves for neat resins, composites (PE and CF) and hybrid composites tested at 180° C. (thermoforming conditions), according to some embodiments of the present disclosure. (Matrix synthesized according to Formulation F1 in the table illustrated in FIG. 2B.)

FIG. 10 illustrates flexural tests of individual composites depicted in FIG. 6 with corresponding material analysis for each set of composites, according to some embodiments of the present disclosure. Panel A illustrates data for HC-8, a composite (not a hybrid composite) made of five plies of a single fiber material (carbon fiber). Panel B illustrates data for HC-7 a laminate interwoven hybrid composite and Panel C illustrates data for HC-2 is an interlaminate woven/interwoven hybrid composite (Matrix synthesized according to Formulation F1 in the table illustrated in FIG. 2B.)

FIG. 11 illustrates photographs of carbon-fiber/PECAN matrix composites before and after being thermoformed in the z-axis direction (perpendicular to the plane of the original composite) at two different z-axis lengths, according to some embodiments of the present disclosure. A carbon-fiber/polyethylene/matrix composite is also shown for comparison. (Matrix synthesized according to Formulation F1 in the table illustrated in FIG. 2B.)

FIG. 12 illustrates a photograph of a composite constructed using a 50/50 carbon fiber/PE fibers (on a weight basis) combined with a thermoset material (matrix material), according to some embodiments of the present disclosure. (Matrix synthesized according to Formulation F1 in the table illustrated in FIG. 2B.)

FIG. 13A illustrates that composites made from all reinforcements (glass, basalt, Kevlar, Kevlar/carbon hybrid, flax, PE, PP, PEEK, and PET) can be recovered for a second use after chemical depolymerization of the PECAN resin (matrix material), according to some embodiments of the present disclosure.

FIG. 13B illustrates the depolymerization reaction performed for the composites illustrated in FIG. 13A, according to some embodiments of the present disclosure.

FIG. 14 illustrates photographs from an experiment that recovered and recycled the components of a composite, according to some embodiments of the present disclosure.

FIG. 15A illustrates a reaction representing methanolysis of a matrix material and photos of composites treated according to the reaction, according to some embodiments of the present disclosure.

FIGS. 15B-D illustrate physical property data of carbon fiber reinforced composites using both woven or chopped carbon fibers, according to some embodiments of the present disclosure.

### REFERENCE NUMBERALS

100 composite
110 fibers
120 matrix material
300 hybrid composite
300A interlaminate hybrid composite
300B interwoven hybrid composite
300C interspersed hybrid composite
310 woven ply
320 interwoven ply
400 vacuum bag molding system
410 mold
415 seal
420 vacuum bag
425 vacuum line
430 breather cloth
440 release film
450 matrix-containing layer
460 fiber-containing layer
470 mold release

### DETAILED DESCRIPTION

The embodiments described herein should not necessarily be construed as limited to addressing any of the particular problems or deficiencies discussed herein. References in the specification to “one embodiment”, “an embodiment”, “an example embodiment”, “some embodiments”, etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

As described herein, to overcome the above-mentioned issues, materials derived from epoxy-anhydride and/or epoxy-amine chemistries are combined with reinforcement materials to produce composite materials with higher performance than any single material utilized in the combination. Further, depolymerization chemistries are described that can be utilized to treat composite materials to recover, among other things, monomers and/or other deconstruction molecules and the original reinforcement materials, e.g., carbon fibers. For example, a composite material having both high strength carbon fibers with ductile polyethylene fibers were combined with a polyester thermoset, resulting in a composite having better performance than many of today's incumbent composites, thereby providing materials that are excellent candidates as steel replacements.

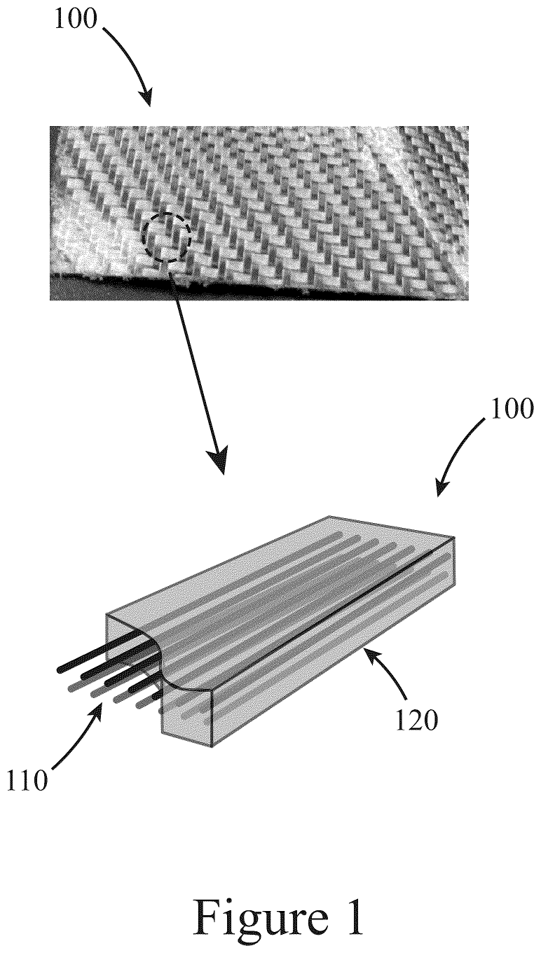

FIG. 1 illustrates a composite 100, according to some embodiments of the present disclosure. The top panel of FIG. 1 illustrates a photograph of an exemplary composite 100 constructed using a 50:50 weight ratio of carbon fiber to PE fibers combined with a polyester thermoset material, at a 50:50 weight ratio of combined fibers to polyester thermoset material. The bottom panel of FIG. 1 illustrates a cartoon simplification of a magnified portion of the composite illustrated in the top panel (not drawn to scale). The magnified portion illustrates that a composite 100 may be constructed of a plurality of fibers 110 (e.g., in the form of a mat) and a matrix material 120, where the matrix material 120 includes at least one of a polymer and/or resin, for example a thermoset. In some embodiments of the present disclosure, a matrix material 120 may include a polyester thermoset. A matrix material 120 and a plurality of fibers 110 may be positioned adjacent to one another and/or in physical contact, resulting in a composite 100 that is, in some embodiments, a layered mixture (e.g., a laminate, oriented or not oriented) and/or a discontinuous mixture. In some embodiments of the present disclosure, a composite 100 may include a plurality of fibers 110 where a matrix material 120 has infiltrated into the spaces between neighboring fibers. In some embodiments of the present disclosure, a matrix material 120 may be present as a substantially continuous phase with a plurality of fibers 110 positioned dispersed throughout the matrix material 120. In some embodiments of the present disclosure, the material making up the matrix material 120 of a composite 100 may have a weight concentration between 5 wt % and 99.9 wt % relative to the total weight of the composite 100.

A number of factors may influence the final physical properties, performance metrics, and/or shapes of the resultant composites 100. These include the method of manufacturing, starting materials used, and chemistries used to produce the matrix material 120 and/or fibers 110. Referring again to the bottom panel of FIG. 1, this illustrates an exemplary composite 100 having a substantially planar structure. However, this is shown for illustrative purposes and is not intended to be limiting. A composite 100 may be in other forms, other than a planar form. For example, a composite 100 may be in a form resulting from a starting planar composite that was shredded and/or reduced in size. Such size reduction may be achieved by processing a starting composite (planar or otherwise) in a hammer mill, knife mill, and/or other size reducing unit operation. As a result, a composite 100 exiting a size reducing operation may be in the form of irregular fragments, chards, strips, etc. Further, composites 100 are often fabricated in intricate molds that can provide a variety of geometries (concave, convex, sloped, angled, etc.) where the fibers are laid onto the mold dry (called layup) and resin and/or polymer (i.e., matrix material) is infused and cured within the fibers. Thus, a composite 100 may have a variety of shapes and geometries, other than and/or in addition to simple planar shapes.

Referring again to FIG. 1, fibers 110 positioned within a matrix material 120 of a composite 100 may also assume many forms. A plurality of fibers 110 and/or tows may be unidirectional or a weave of fibers, including at least one of a plain weave, a twill weave, and/or a harness satin weave and/or a honeycomb. An individual layer constructed of a plurality of fibers is referred to as a “ply”. A weave may be constructed, in any direction, of a plurality of interwoven bundles of strands called “tows”. Tows may be oriented in any direction from 0° to 90° and stacked on top or woven (twill, plain, satin, honeycomb, etc.) within any direction from 0° to 90°. Further, fibers 110 positioned within a matrix material 120 of a composite 100 may include continuous strands and/or discontinuous fibers of any length. Further, in some embodiments of the present disclosure, fibers may be a collection of randomly shaped and randomly oriented fibers and/or having fibers of random length and/or diameter, referred to herein as a “chopped” fibers, with composites 100 using such fibers 110 referred to herein as “chopped” composites 100.

In some embodiments of the present disclosure, fibers 110 may each be made of a single material. Alternatively, fibers 110 may include a mixture of fibers from multiple sources and/or made of two or more different materials. In some embodiments of the present disclosure, fibers in composites 100 may be constructed using at least one of a carbon fiber, a glass fiber, a ceramic fiber, a basalt fiber, a natural-occurring fiber (e.g., plant-based fiber-hemp, bamboo, jute, flax, etc., and/or animal-based fiber), a synthetic polymer fiber, and/or a synthetic resin fiber. Examples of synthetic materials that may be used to produce fibers 110 used in a composite 100 include polyethylene (PE), polypropylene (PP), polyethylene terephthalate (PET), a polycarbonate, an acrylic material, a polyamide, an aramid fiber (e.g., Kevlar®, polyparaphenylene terephthalamide), a polyether ether ketone (PEEK), polystyrene, and/or acrylonitrile butadiene styrene (ABS).

In some embodiments of the present disclosure, a plurality of fibers 110 may be constructed using carbon fibers and fibers constructed of a thermoplastic material, e.g., PE and/or PP, and/or some other reinforcement material (as listed above). In some embodiments of the present disclosure, a fiber weave may be constructed of between greater than 0 wt % carbon fiber and less than or equal to 100 wt % carbon fiber, with the remainder constructed of at least one of a synthetic fiber and/or a natural occurring fiber, with examples provided above. In some embodiments of the present disclosure, a plurality of fibers 110 may be combined with a thermoset matrix material 120, where the fibers 110 include a combination of several types of fibers, for example one or more inorganic fibers (e.g., carbon fiber, glass fiber, and/or basalt fiber, etc.) and/or one or more synthetic fibers (e.g., polyethylene and/or polypropylene, etc.), where the combination of different fiber materials and the thermoset matrix material 120 results in an increase in the ductility of the resultant composite 100 and/or an improvement in some other physical property and/or performance metric.

Referring again to FIG. 1, a matrix material 120 may be constructed using a polyester and/or a polymer containing ester groups. As shown herein, a matrix material 120 of a thermoset constructed with repeat units containing ester groups and hydroxy groups may provide several advantages over other types of polymers/resins and/or over other types of thermosets. For example, matrices 120 containing ester functional groups (3-D polymer networks including ester-containing repeat units) may be combined, impregnated, and cured with a plurality of fibers 110, resulting in composites 100 having improved physical properties and/or performance metrics. In some embodiments of the present disclosure, fibers 110 may be infused with a matrix material 120 containing ester functional groups (3-D polymer networks including ester-containing repeat units) to create a composite 100.

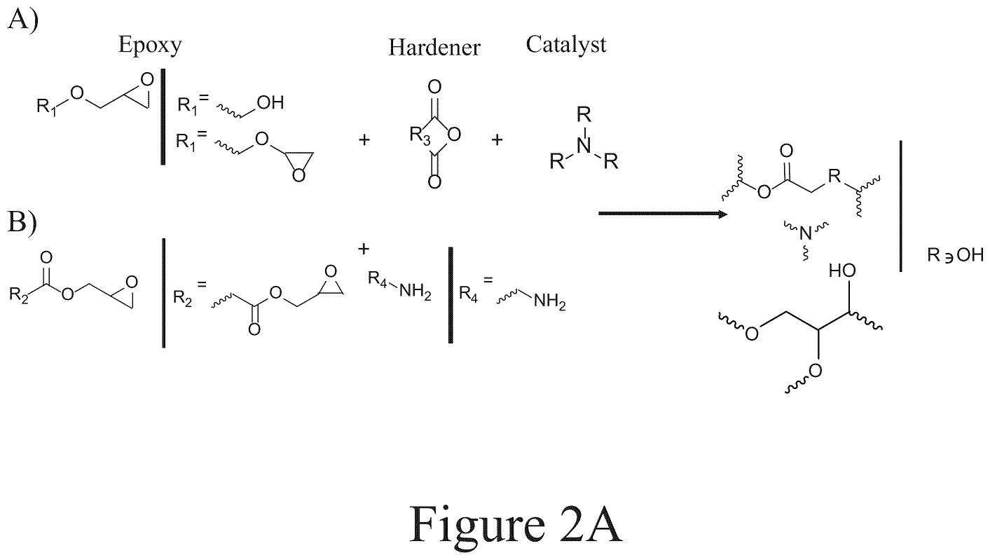

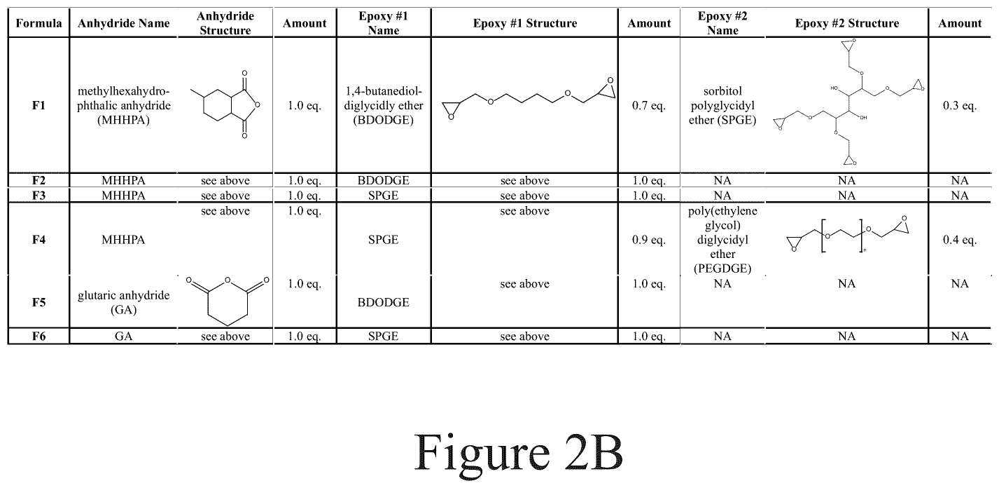

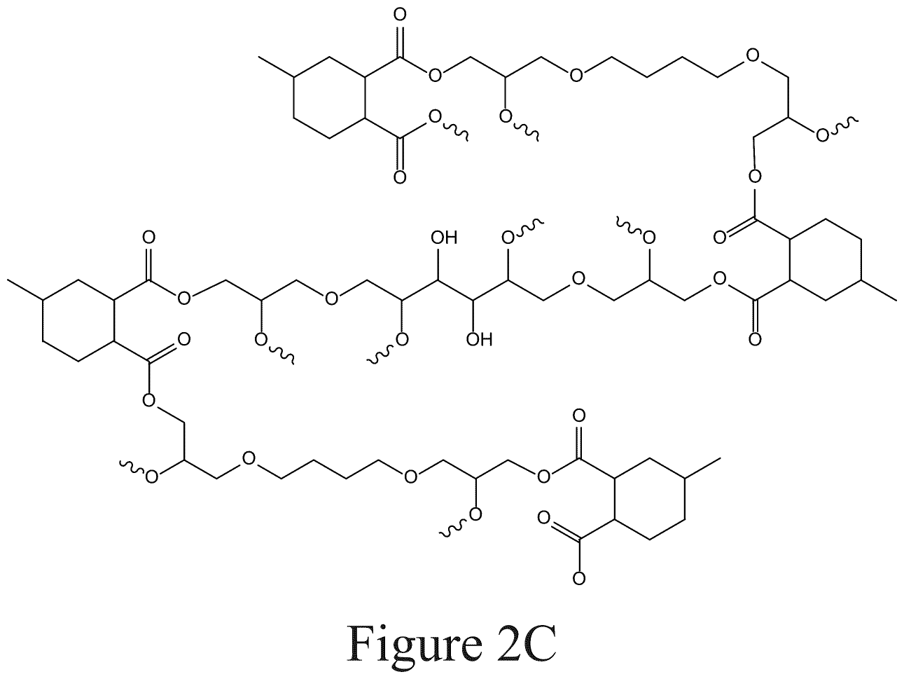

FIG. 2A illustrates a synthetic route for producing polymers and/or resins suitable for use as a matrix material 120 for combining with fibers 110 to yield improved composites 100, according to some embodiments of the present disclosure. FIG. 2A shows that ester-containing polymers (i.e., polyesters) and/or resins may be synthesized by (Panel A) reacting epoxy and hydroxy containing starting materials with a cyclic anhydride hardener and a tertiary amine catalyst like imidazole or triethylamine or (Panel B) reacting a diglycidyl ester with an amine hardener. For example, referring to catalysts for producing polyesters, R may be a hydrocarbon chain (between 0 and 20 units) that can also include at least one of oxygen, nitrogen, phosphorus, and/or sulfur. Specific examples of catalysts suitable for producing polyesters include imidazole triethylamine and any tertiary amine. Scheme 1 below summarizes the structures of some exemplary catalysts suitable for the reactions illustrated in FIG. 2A.

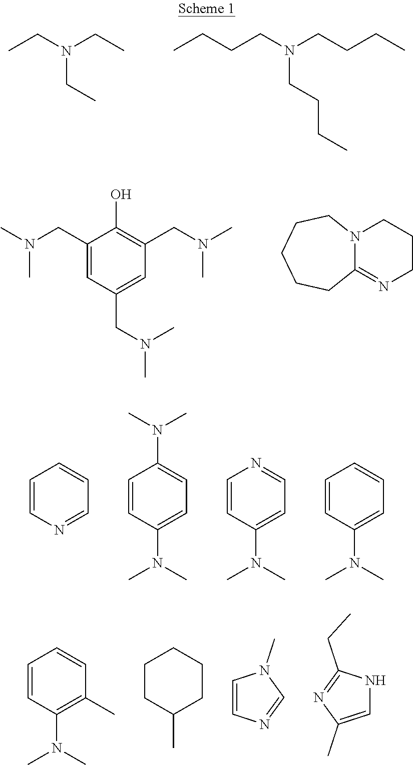

Referring again to FIG. 2A, in some embodiments of the present disclosure, a catalyst may or may not be incorporated into the final polymer. R may be tuned to achieve desired physical properties, manufacturing requirements, and/or performance metrics. In some embodiments of the present disclosure, R₁ may include at least one of a hydroxy group and/or at least one additional glycidyl ether. In some embodiments of the present disclosure, R₂ may include at least one additional glycidyl ester. R₃ may be a hydrocarbon chain (between 0 and 20 carbon atoms, inclusively) that maintains the overall cyclic shape of the molecule containing R₃. In some embodiments of the present disclosure, R₃ may further include at least one of oxygen, nitrogen, phosphorus, and/or sulfur, so long as it is a cyclic molecule. In some embodiments of the present disclosure, R₄ includes an additional amine group.

FIG. 2B summarizes six different formulations for synthesizing polyester thermosets for use as matrix material 120 materials, utilizing different reactants. Anhydrides were utilized as hardeners. Each formulation was synthesized and the physical properties of the resultant neat polyester thermosets measured, with the results for tensile strength, toughness, and % elongation summarized in Table 1 below. Formulation F1 was chosen for subsequent experiments synthesizing different composites 100 and hybrid composites, where a hybrid composite is defined as a composite constructed using more than type of fiber (e.g., both carbon fiber and fibers made of polyethylene). FIG. 2C illustrates a structure corresponding to polyester thermoset resulting from Formulation F1, according to some embodiments of the present disclosure. The polyester thermoset illustrated in FIG. 2C is constructed of three repeat units, as shown in Scheme 2 below, where repeat unit A) is derived from methyl hexahydrophthalic anhydride (MHHPA), repeat unit B) is derived from 1,4-butanediol-diglycidly ether (BDODGE), and repeat unit C) is derived from sorbitol polyglycidyl ether (SPGE). Another epoxy that may be used to synthesize a polyester thermoset, (see Formulation F4, see FIG. 2B) is poly(ethylene glycol) diglycidyl ether (PEGDGE).

TABLE 1
Polyester Thermoset Matrix Material Properties

| | | Tensile Strength | Tensile Toughness |
|---|---|---|---|
| Formulation | % Elongation | (MPa) | (MJ/m³) |
| F1 | 6.7 ± 1.1 | 66 ± 6 | 280 ± 50 |
| F2 | 11 ± 1.9 | 53 ± 2 | 400 ± 80 |
| F3 | 3.4 ± 0.6 | 45 ± 6 | 80 ± 25 |
| F4 | 15.7 ± 2.1 | 18 ± 1 | 228 ± 38 |
| F5 | 16.1 ± 2.0 | 2.5 ± 0.2 | 21 ± 5 |
| F6 | 8.0 ± 0.9 | 49 ± 3 | 270 ± 50 |

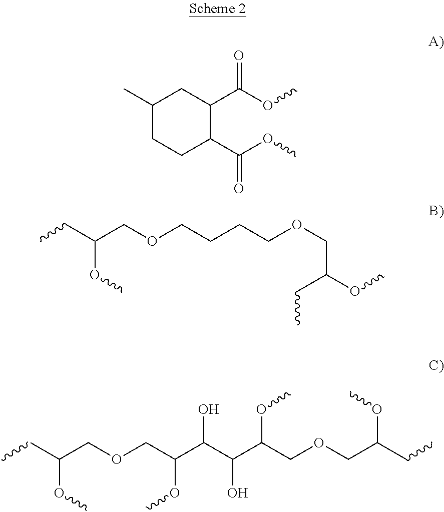

In addition, the covalent adaptable bond exchange that is afforded by the polyester thermoset chemistry illustrated in FIG. 2A provides numerous advantages for full-scale manufacturing of composites. One advantage is short synthesis times, for example, synthesis times of less than two hours, or less than 60 minutes, or less than three minutes. Additionally, composites 100 that include a polyester thermoset matrix material 120 having ester-containing repeat units can offset manufacturing burdens (cost and GHG emissions, discussed more below) and can positively impact the carbon economy through the recovery of the materials used to make the composite via chemical depolymerization. This aspect can incentivize recovery, recycle, and/or reuse of both thermoset components and fibers in an economic and environmentally friendly fashion. The aspects of recovery, recycle, and/or reuse is discussed in more detail below.

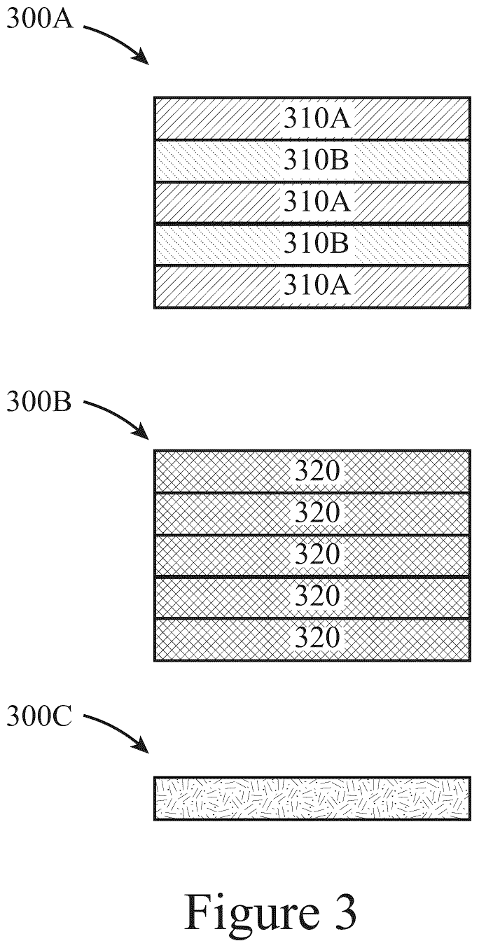

In addition to the choice of material used for a matrix material 120, the variety of materials available for constructing both fibers 110 and matrices 120, combined with the variety of forms available for making different fiber weaves, enables the thermoforming of a variety of cured laminates, including hybrid composites (HC), where the term HC refers to a composite 100 constructed using more than one type of fiber. One mixture of fibers tested in various hybrid composites described herein are carbon fibers and polyethylene fibers. Three exemplary types of hybrid composites 300 are illustrated in FIG. 3. Panel A) illustrates an “interlaminate” hybrid composite 300A, which is constructed using a stack of alternating fiber layers (i.e., alternating plies) made of different fiber materials. Each ply is constructed using a single fiber type/material. It is referred to as an interlaminate because of the alternating compositions of the plies making up the composite. The exemplary interlaminate hybrid composite 300A shown in Panel A) is constructed of a total of five plies of woven fibers, a first set of three plies constructed solely of a single material of woven fibers, e.g., only carbon fiber (CF), referred to herein as a woven ply 310A, and a second set of two plies constructed of a second material different from the material used in the first set, e.g., only PE fiber, referred to herein as woven ply 310B. In this example, the plies are alternated, CF/PE/CF/PE/CF, or referring to the reference numerals illustrated, 310A/310B/310A/310B/310A. Other interlaminate hybrid composites 300 fall within the scope of the present disclosure.

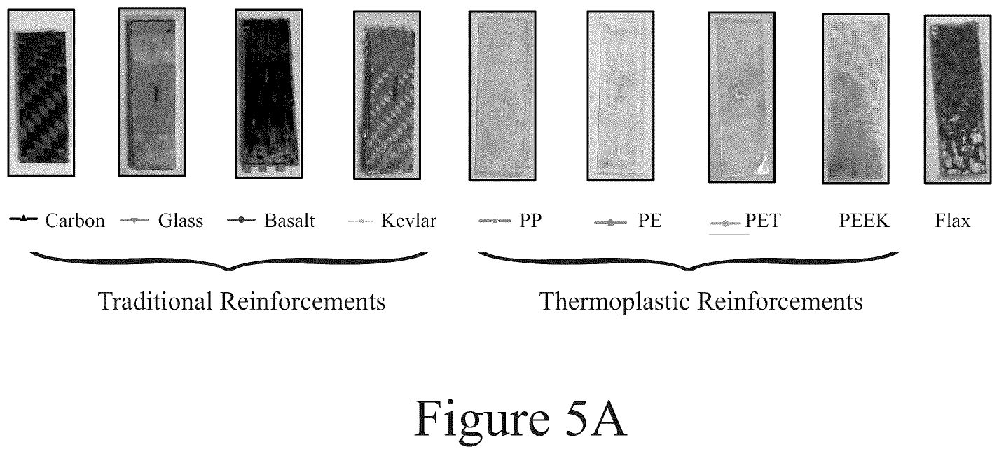

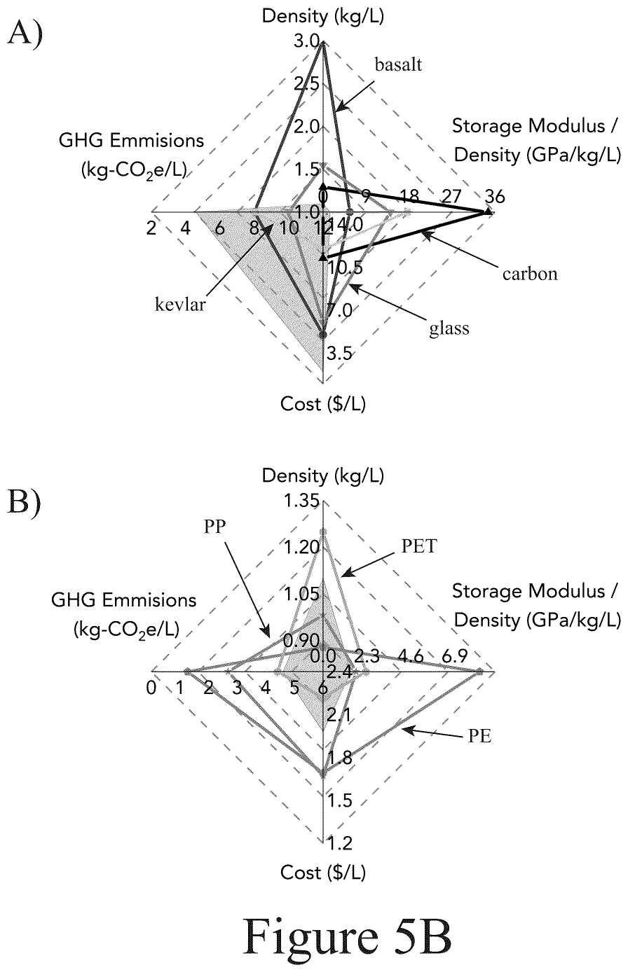

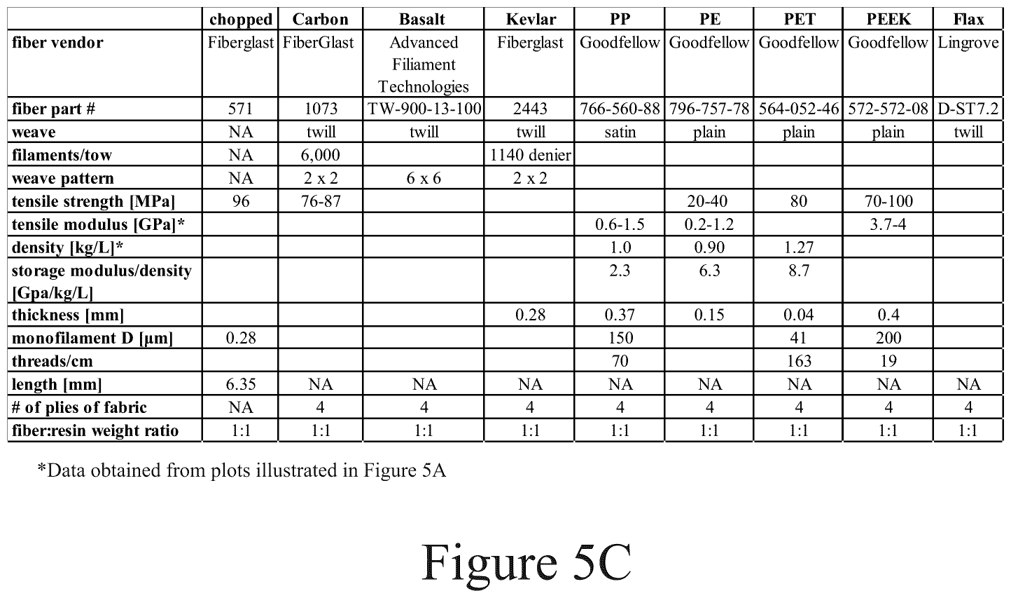

Panel B) of FIG. 3 illustrates a second example of a hybrid composite, an “interwoven” hybrid composite 300B constructed of plies constructed of two or more types of fiber, each fiber type constructed of a different material, where the two or more fiber types are interwoven into a single ply, referred to as an interwoven ply 320. An example of an interwoven ply is a ply constructed of carbon fibers interwoven with PE fibers. The interwoven HC illustrated in Panel B) is constructed with five interwoven plies (each labeled 320) of a single interwoven composition, with each ply constructed of both carbon fibers and PE fibers. An interwoven HC 300B can have one or more interwoven plies 320 where each ply is interwoven fibers of two or more different materials. In some embodiments of the present disclosure, an interwoven HC 300B may be constructed with interwoven plies having different fiber compositions. For example, a first interwoven ply may be constructed of PE, PP, and CF and second interwoven ply may be constructed of just PE and CF or fibers constructed of completely different materials (see FIG. 5A for examples).

The concept of an interlaminate HCs can be combined with the concept of interwoven HCs to form other composite structures. Two such compositions are discussed in more detail below referred to herein as HC-2 and HC-7. HC-2 is also an interlaminate HC constructed of alternating plies having two different types of plies, one interwoven and one woven: five plies constructed of 1) a bottom interwoven layer (i.e., ply) that is 30% PE/70% CF, 2) a layer of 100% woven CF, 3) a second interwoven layer that is 30% PE/70% CF, 4) a second layer of 100% woven CF, and 5) a top, third layer that is 30% PE/70% CF. This is referred to as an interlaminate woven/interwoven hybrid composite (twill weave for each layer). HC-7 is a laminate hybrid composite constructed of five identical plies of interwoven PE and CF, 50% PE and 50% CF (twill weave for each layer). This is referred to as a laminate interwoven hybrid composite.

Panel C) of FIG. 3 illustrates a third example of a hybrid composite, an “interspersed” hybrid composite 300C constructed of a mixture of chopped fibers. Like the other two hybrid composites (300A and 300B), an interspersed HC 300C may combine fibers constructed of different materials, e.g., carbon fibers with PE fibers, where the different fiber types are randomly mixed and interspersed throughout the matrix. In some embodiments of the present disclosure, an interspersed HC 300C may be produced by manufacturing separately a CF mat and a PE mat, chopping and/or shredding the individual mats into smaller pieces and then combining the chopped CF and the chopped PE to create an “interspersed” mixture of CF and PE fibers, which may then be combined with a matrix material to yield the “interspersed” hybrid composite, with the fibers randomly distributed. Although the example of an interspersed HC 300C is shown with only one ply, interspersed HCs 300C may be constructed of one or more plies of chopped, interspersed fibers.

Referring again to Panels A and B of FIG. 3, the interlaminate HC 300A and interwoven HC are shown as containing five plies. However, an interlaminate HC 300A may be constructed of two or more plies, for example, between 2 and 10 plies or between 2 and 6 plies, where the plies alternate the material used for the fibers. Similarly, an interwoven HC 300B may be constructed of two or more plies, for example, between 2 and 10 plies or between 2 and 6 plies, where each ply contains two or more types of fiber that are interwoven. As described above, fibers and/or tows may be woven into various weaves; e.g., plain weave, a twill weave, a harness satin weave, a honeycomb weave, and/or a veil weave. In some embodiments the present disclosure, each ply of a composite may have the same weave. However, in some embodiments of the present disclosure, an interlaminate composite or an interwoven composite may be constructed of plies having different weaves.

Methods for manufacturing composites are well known. Thus, a variety of processes may be used to produce the composites 100 described herein. Examples of suitable processes include vacuum bag molding, resin transfer molding, vacuum infusion, compression molding, pultrusion, injection molding, electrospinning, and/or filament winding. Each of these processes are described in detail in a reference (Polymers 2019, 11, 1667; doi: 10.3390/polym11101667), which is incorporated herein by reference in the entirety.

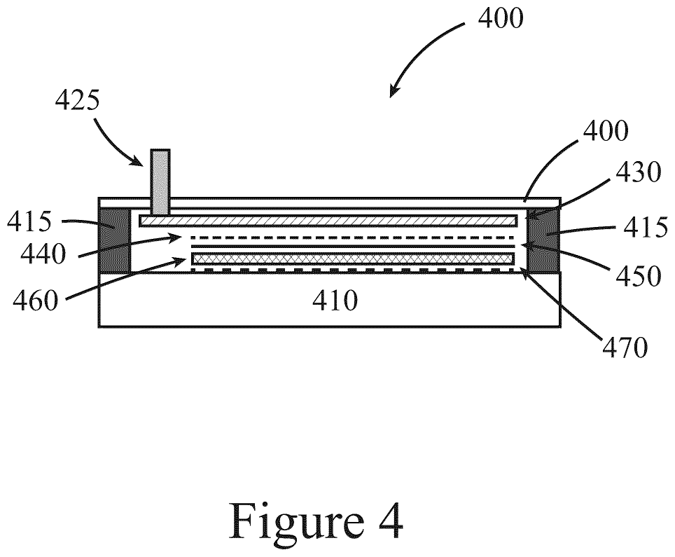

FIG. 4 illustrates an exemplary system, vacuum bag molding system 400, for producing a composite 100, according to some embodiments of the present disclosure. This is provided for enabling purposes and is not intended to be limiting. The process conditions provided represent typical conditions used in the laboratory and are also provided for exemplary purposes and should not be considered limiting. The exemplary system 400 illustrated in FIG. 4, includes a mold 410 into which a stack is positioned that includes, from the bottom up, a mold release 470, a fiber-containing layer 460, a matrix-containing layer 450, a release film 440, and a breather cloth 430. These were sealed within a vacuum bag 420 using sealant tape as a seal 415. The vacuum bag 420 contained an vacuum line 425 leading to a vacuum source (not shown). Resin (i.e., the material to formulate a matrix material 120) mixtures were initially homogenized by hand-stirring and were subsequently speed-mixed for 10 seconds at 1000 RPM and 2 minutes at 2000 RPM. The uncured resin precursors were then degassed for 10 minutes under vacuum. The resin precursors were then infused by hand by adding an equal mass to fiber loading of the resin to the dry fibers. This mass ratio of dry fiber to resin of 1:1 was used for every composite made and tested and reported in this disclosure. Resin was equally dispersed in the fibers via a squeegee. An aluminum flat mold was coated with FibRelease 1153 (mold release) and the impregnated fibers were placed on the flat mold. A high temperature release film was placed on top, followed by the breather cloth and finally Nylon bagging film was secured on top of the mold by sealant tape. The vacuum bagging set up was put in a Lingberg Blue M oven at 80° C. where vacuum was applied, resulting in the curing of precursors to form the matrix material 120 and the resultant composite 100. Chopped composites were made by hand-mixing uncured resins in a 35 mm×13 mm×1 mm Teflon mold at a 90 wt % resin (matrix material) content. The composites were cured isothermally for 5 hours. Cured laminates were then post-cured at 180° C. for 2 hours to ensure complete reaction of all monomers. Lastly, the composites were cut into test specimens for mechanical testing using a diamond saw.

The fiber selected for a composite does not just impact the physical properties of the final composite. In addition, the materials and processes used to make a particular fiber are also important and can have dramatic effects on GHG emissions, cost, density, and lightweighting, associated with making composites. FIG. 5A illustrates photographs of different materials constructing fibers that may be used in composites as described herein, include a group used in traditional reinforcements (carbon, glass, Kevlar, etc.) and a group using thermoplastics to produce fibers used in composites, according to some embodiments of the present disclosure. (The matrix material used in each composite was synthesized according to Formulation 1 (F1) in the table illustrated in FIG. 2B.) Each composite was constructed using a 1:1 weight ratio of matrix material to fiber.

FIG. 5B compares the effects of the different fiber-containing composites illustrated in FIG. 5A on greenhouse gas (GHG) emissions, cost, density, and lightweighting, according to some embodiments of the present disclosure. Panel A corresponds to composites constructed using traditional reinforcements and Panel B to composites constructed using thermoplastic reinforcements. Twill weave was used for some of the fiber materials, as it has advantages from a circularity and recyclability perspective and is less prone to physical degradation. However, satin and plain weaves were also tested. Each composite was constructed using four plies of fiber. Referring again to FIG. 5B, shown on the left radar plot are traditional reinforcements such as carbon, glass, basalt, and Kevlar® compared to 304 stainless steel (shaded fill). Shown on the right radar plot are results for composites using the F1 resin (matrix material) formulation in combination with thermoplastic fiber materials such as polypropylene (PP), polyethylene (PE), polyethylene terephthalate (PET) compared to steel. These data show that the use of these non-traditional fibers as reinforcements in composites can drastically reduce manufacturing costs and GHG emissions, while still providing a competitive modulus/density (>2 GPa/kg/L). FIG. 5C tabulates some of the parameters, metrics, and physical properties for the composites illustrated in FIG. 5A.

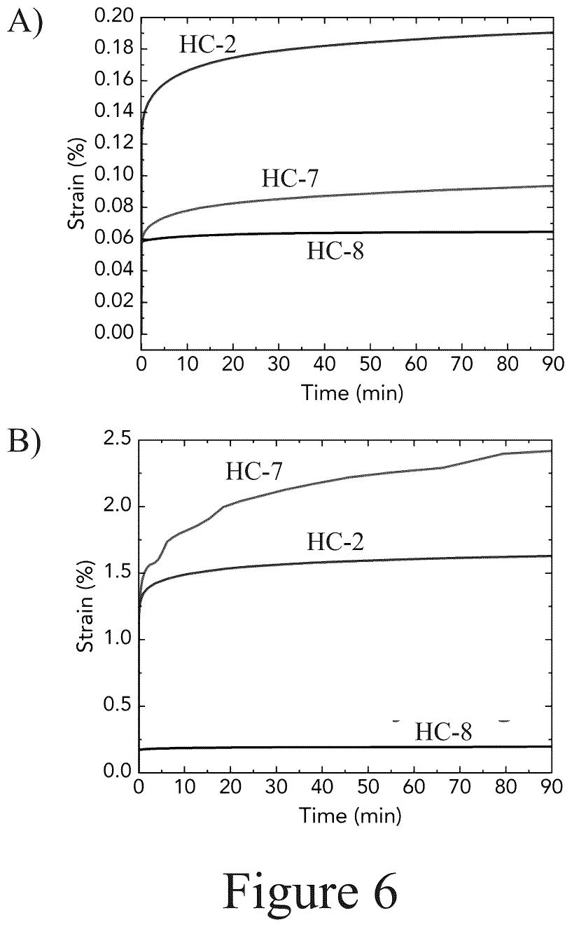

FIG. 6 illustrates strain curves of fiber containing different amounts of polyethylene/carbon interwoven fibers combined with carbon fibers in an interlaminate fashion, these then combined with a polyester thermoset (Formulation 1), i.e., matrix material, to make two hybrid composites (HC-2 and HC-7 described above), according to some embodiments of the present disclosure. HC-8 is not a hybrid composite because its composition only includes laminated five plies of woven carbon fiber, so HC-8 is referred to herein as a laminate woven composite (using twill weave for each layer). The composites referred to herein as HC-2 and HC-7 are both hybrid composites in that they each contain both CF and PE fiber, each with five plies.

As described above, HC-2 is an interlaminate woven/interwove HC, having five plies 1) a bottom interwoven layer (i.e., ply) that is 30% PE/70% CF, 2) a layer of 100% woven CF, 3) a second interwoven layer that is 30% PE/70% CF, 4) a second layer of 100% woven CF, and 5) a top, third layer that is 30% PE/70% CF. It is referred to as an interlaminate because of the alternating compositions of the plies making up the composite. As described above, HC-7 is a laminate interwoven composite constructed of five identical plies of interwoven PE and CF, 50% PE and 50% CF.

These different composite designs, HC-2, HC-7, and HC-8, illustrate that a hybrid composite can include both layers of interwoven fibers of different types (e.g., CF and PE) and/or a hybrid composite can include layers having one or more layers made entirely using a first fiber type (e.g., only CF) combined with one or more layers made entirely using a second fiber type (e.g., only PE fibers). These hybrid composites provided little creep (<0.2%) at slightly elevated temperatures (35° C.), where creep is observed as the deformation (or strain) under a constant load (or force). Conversely, these hybrid composites significantly deformed (>2.0%) at elevated temperatures (160° C.), indicating their ability to be used in thermoforming applications.

TABLE 2
HC-2, HC-7, HC-8 Composites Creep and
Thermoforming Data (From FIG. 6)

| | HC-2 | HC-7 | HC-8 |
|---|---|---|---|
| Strain % at 35° C. | 0.2 | 0.09 | 0.07 |
| Strain % at 160° C. | 1.6 | 2.4 | 0.22 |

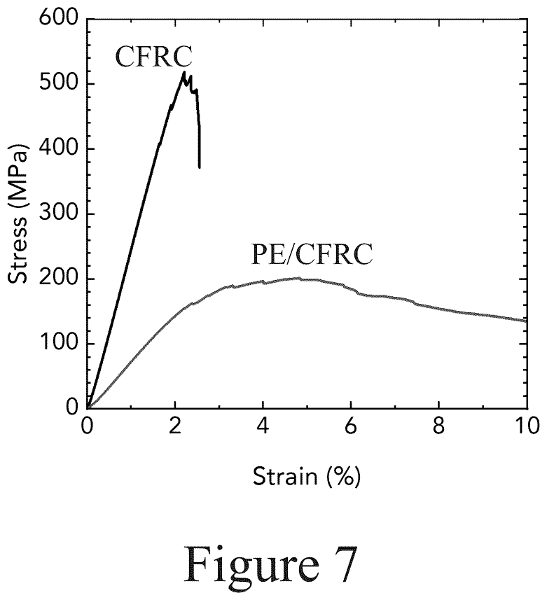

FIG. 7 illustrates plots of flexural strength versus flexural strain from a first non-hybrid composite (CFRC) and hybrid composite using the hybrid composite labeled HC-7 (labeled PE/CFRC) in FIG. 6, according to some embodiments of the present disclosure. The resin formulation used as the matrix material for both compositions illustrated in FIG. 7 was Formulation 1. Again, the CFRC sample was technically not a hybrid composite, as it only included one fiber type, carbon fiber. This material failed relatively abruptly at about 2% strain, whereas the inclusion of the PE fiber (at 50% in an interwoven laminate) continued to deform without breaking, even after >10% strain.

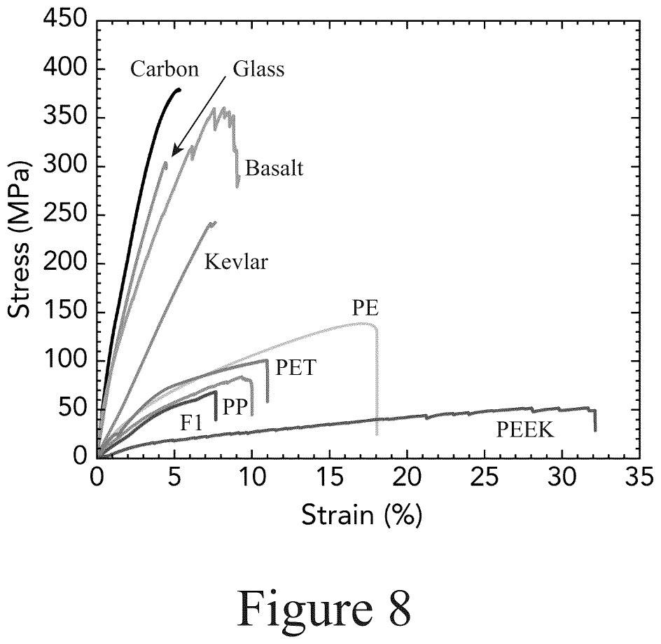

FIG. 8 illustrates tensile stress/strain curves of a neat resin (F1 formulation) and composites resulting from combining the F1 matrix material with various types of fiber (not mixtures of different fibers, such as PE fibers with CF), according to some embodiments of the present disclosure. These curves show composite performance is heavily dependent on the choice of fiber, particularly the ductility (high strain) observed for composites using thermoplastic matrices. FIG. 8 illustrates, for example, that the strain at break varies significantly: carbon fiber failed at a strain of about 5%, PE at a strain of about 18%, glass at a strain of about 4%, basalt at about 5%, Kevlar® at about 8%, PP at about 10%, PET at about 11%, and PEEK at about 32%. Neat matrix material (resulting from the F1 formulation), in the absence of fiber, demonstrated failure at a strain of about 7.5%. Thus, strains at break for these tested materials ranged between 4% and 32%. The results illustrated in FIG. 8 are tabulated below in Table 3. However, the possible strain ranges for a composite 100 may vary significantly beyond the boundaries tested herein. For example, in some embodiments of the present disclosure, the strain at break for a composite may be between 0.1% and 800% or between 3% and 33%.

TABLE 3
Tensile Stress/Strain Curve Summary from FIG. 8

| | % strain at | stress at break |
|---|---|---|
| material | break | [MPa] |
| Resin | 7.7 | 70 |
| Carbon | 5.5 | 375 |
| PE | 18.0 | 140 |
| Glass | 4.3 | 300 |
| Basalt | 8.0 | 360 |
| Kevlar | 7.0 | 240 |
| PP | 10.0 | 80 |
| PET | 11.0 | 100 |
| PEEK | 32 | 50 |

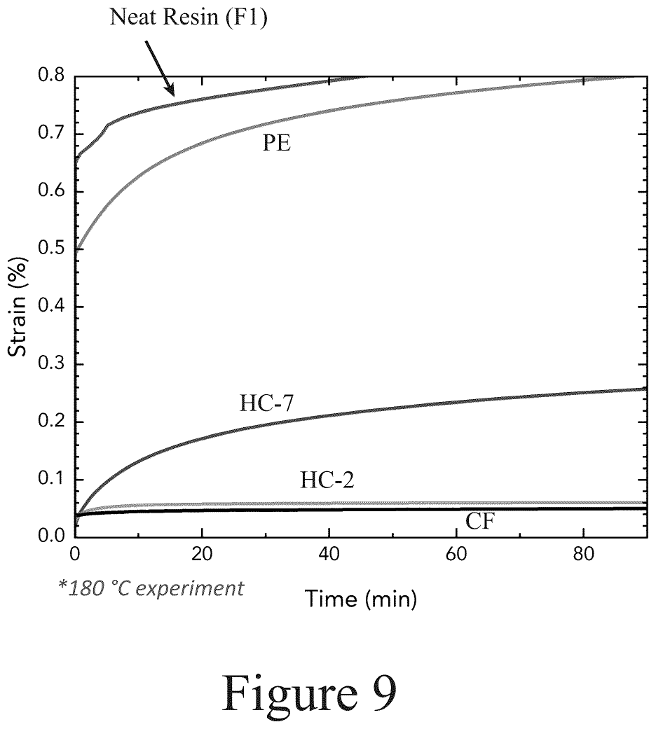

FIG. 9 illustrates plots of strain as a function of time when a normalized stress (1 MPa) was applied to each of a neat thermoset matrix material, i.e., “neat resin” (formulation F1), a standard laminate woven composite using a single ply of either PE (labeled PE), or carbon fiber (labeled CF), and two hybrid composites, a laminate interwoven hybrid composite (HC-7) and an interlaminate woven/interwoven hybrid composite (HC-2) of pure alternating PE woven plies and pure CV woven plies). As stress was applied to the materials at a constant temperature of 180° C., these experiments evaluated the thermoforming capabilities of these materials. Referring again to FIG. 9, the woven carbon fiber layer demonstrated almost no thermoforming strain, even at the elevated temperature, as would be expected for traditional, low-strain reinforcements. The woven PE composite layer, however, demonstrated the thermoforming capability of the neat resin. The laminate interwoven hybrid composite (HC-2) demonstrated nominal strains as the stresses were evenly distributed within the composite layer, showing an optimal layup for thermoforming. The interlaminate woven/interwoven hybrid composite (HC-2) failed to deform appreciably as stresses were unable to equitably distribute. The data illustrated in FIG. 9 are tabulated below in Table 4.

TABLE 4
Strain at 90 Minutes at 180° C. from FIG. 9

| Material | % Strain |
|---|---|
| Neat Resin (F1) | 0.86 |
| PE (woven) | 0.80 |
| CF (woven) | 0.05 |
| HC-7 | 0.26 |
| HC-2 | 0.05 |

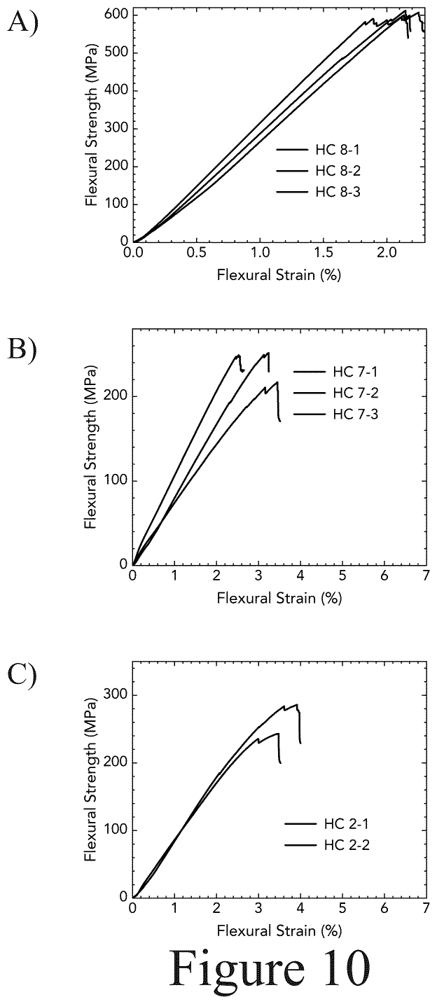

FIG. 10 illustrates 3-point bend flexural stress/strain curves and flexural properties for the hybrid composites HC-2 and HC-7 and the HC-8 composite as described above for FIG. 6. These same composites were tested to yield the data shown in FIG. 10. As before, the composite labeled HC-8 only includes carbon fiber in the form of an interlaminate having four layers of only carbon fiber (no second type of fiber made of, for example, PE). HC-2 and HC-7 are hybrid composites that contain both CF and PE fibers. HC-2 is an interlaminate woven/interwoven hybrid composite. HC-7 is a laminate interwoven hybrid composite. Several replicates for each composite were performed and are presented in Panels A-C, where HC-8-X are replicates of HC-7-X are replicates of HC-7 and HC-2-X are replicates of HC-2. The average strength, strain, toughness, and modulus for the sample sets are tabulated below in Table 5. Both composites with PE (HC-7, HC-2) show lower strength and modulus but higher strain than the sole carbon fiber analog (HC-8). This effectively shows the propensity for PE incorporation to enable a more ductile composite response.

TABLE 5
Composite Physical Properties

| property | HC-8 | HC-7 | HC-2 |
|---|---|---|---|
| Flexural strength (MPa) | 607 ± 4 | 240 ± 15 | 265 ± 20 |
| Flexural strain (%) | 2.18 ± 0.05 | 3.40 ± 0.10 | 3.7 ± 0.2 |
| Flexural toughness (MJ/m³) | 709 ± 70 | 406 ± 30 | 580 ± 80 |
| Flexural modulus (GPa) | 31.4 ± 1.6 | 8.7 ± 1.2 | 9.3 ± 0.4 |

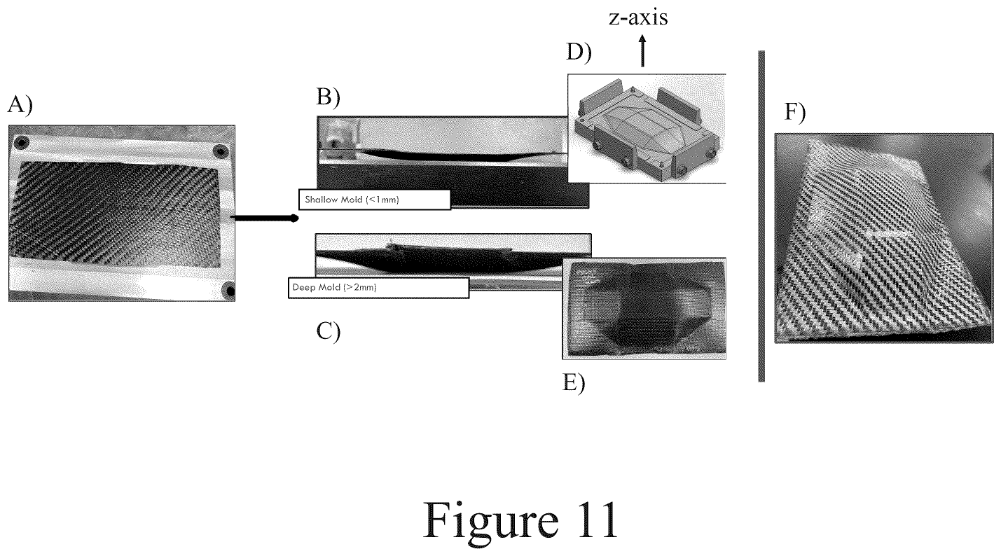

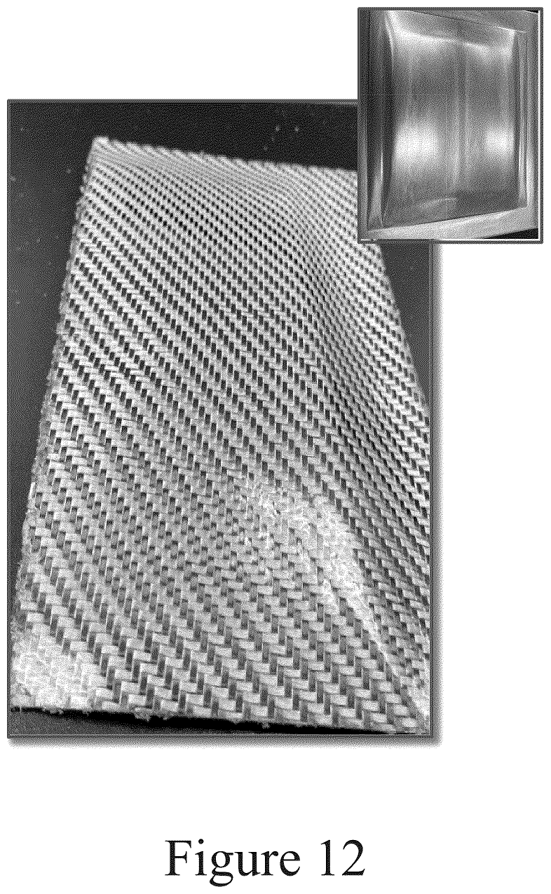

FIG. 11 illustrates photographs of carbon-fiber/thermoset twill weave composites before (Panel A) and after (Panels B and C) being thermoformed in the z-axis direction (i.e., elevation direction) (Panel D), according to some embodiments of the present disclosure (using F-1 resin formula at a 1:1 fiber to resin weight ratio). These results show that when using a shallow mold, e.g., less than 1 mm (on a 1 mm composite panel) (Panel B) the composite retained its physical integrity. However, when a deeper mold was used (at a value greater than 2 mm (on a 1 mm composite panel) (Panel C/E), the composite cracked and broke, with the carbon fiber splintering. The same deeper mold (Panel D) was used for a CF/PE interwoven twill weave laminate (HC-7) with >2 mm strain (on a 1 mm thick panel) to thermoform without splintering (Panels E and F). These materials were thermoformed while applying a pressure of about 100 psig. However, depending on the composite being manufactured and equipment used, other pressures may be used. In some embodiments the pressure used to thermoform a composite may be between 0 psig and 10,000 psig or between 50 psig and 150 psig. FIG. 12 illustrates a composite 100 constructed using a 50/50 weight ratio of carbon fiber/PE fiber in an interwoven twill weave (HC-7) combined with a thermoset material (Formulation F1 in the table illustrated in FIG. 2B). The resultant composite layer was easily thermoformed at 160° C. for one hour. This resulted in a defect-free molded product, which was achieved at a temperature 20° C. lower than the CFRP test results illustrated in FIGS. 11 and 17 hours faster. In some embodiments the temperature used to thermoform a composite may be between 50° C. and 250° C. or between 150° C. and 200° C.

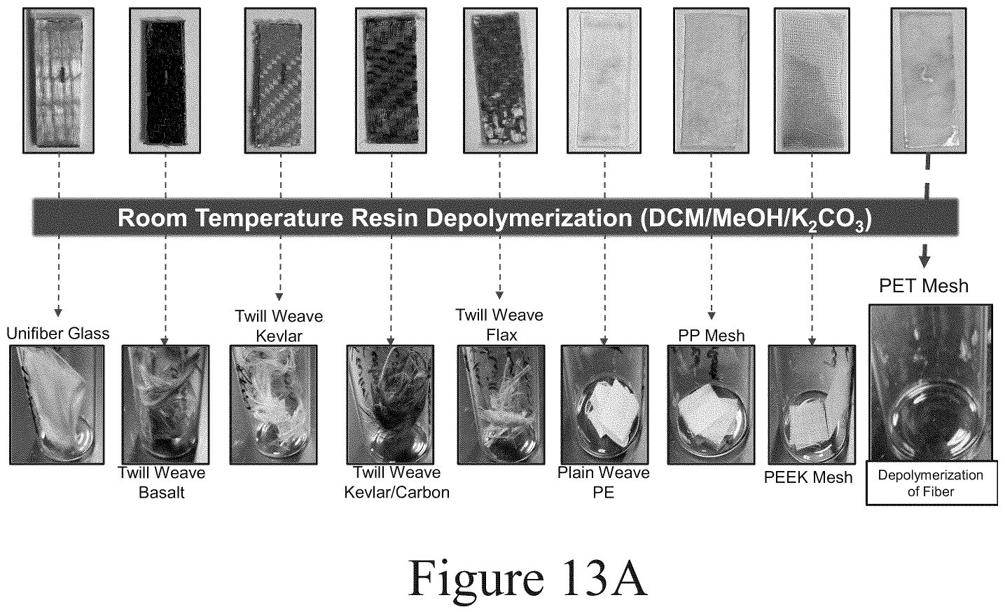

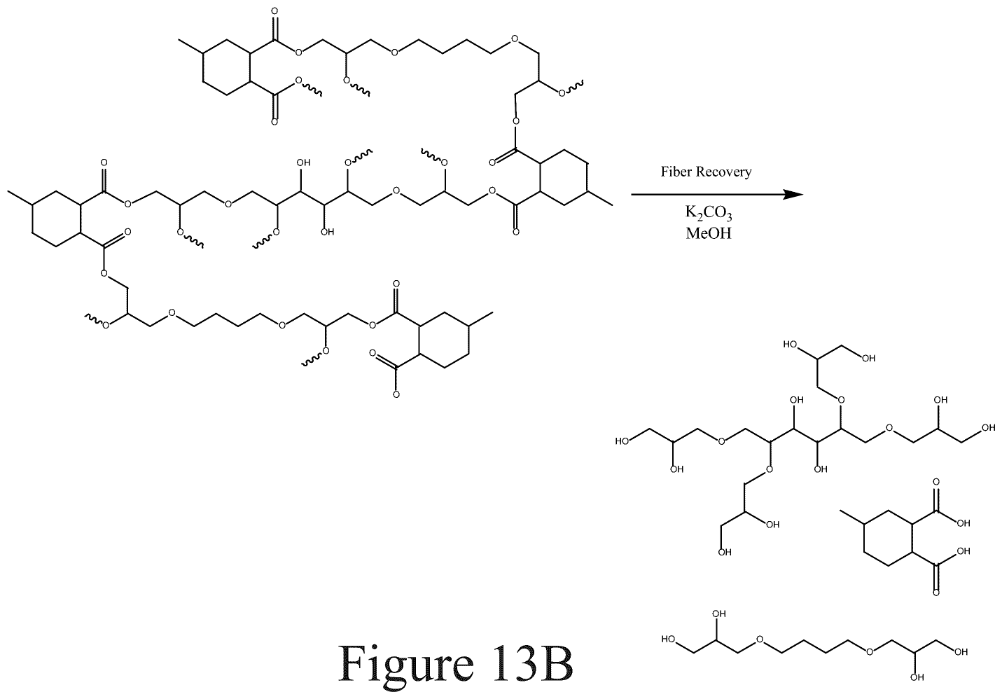

FIG. 13A illustrates composites constructed using alternative fibers and different orientations before and after chemical treatment performed for fiber recovery. Due to the nature of the resin (using the F1 formulation), the matrix material is able to undergo triggered methanolysis at room temperature, which allows for chemical depolymerization of monomers into dimethyl esters and polyols. This depolymerization reaction is summarized in FIG. 13B.

When performed on composites, this enables fiber recovery in a virgin-like state. However, polyester reinforcements or fibers will also undergo methanolysis and yield no recovery of the fibers as observed for polyethylene terephthalate (far right of FIG. 13A). The reinforcements tested include unidirectional glass, twill weave basalt, twill weave Kevlar®, twill weave Kevlar®/carbon hybrid, twill weave flax, plain weave polyethylene, polypropylene veil weave, polyether ether ketone veil weave, and a polyethylene terephthalate veil weave.

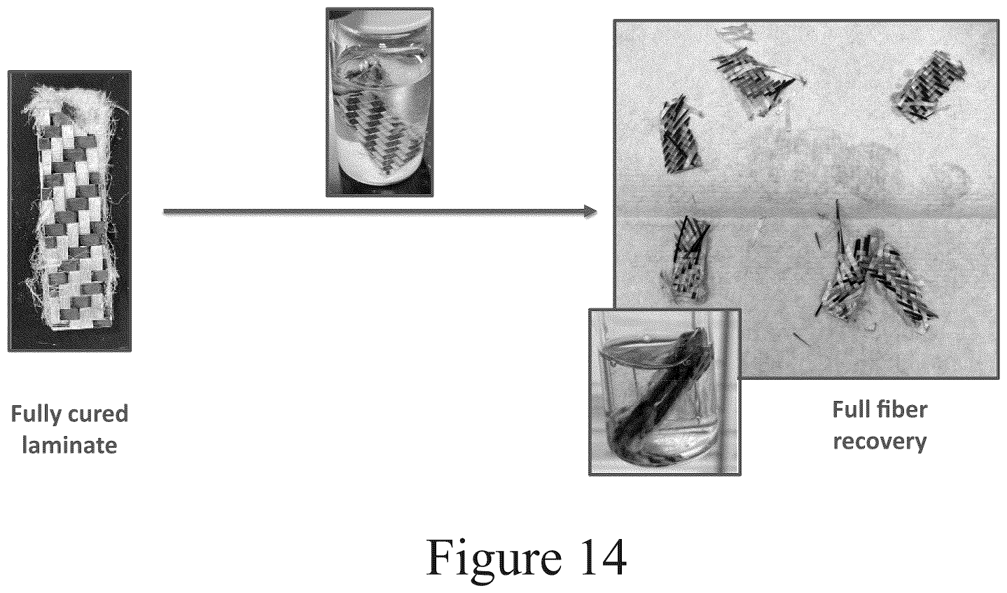

FIG. 14 illustrates photographs from an experiment aimed at recovering and recycling the components of a composite layer, according to some embodiments of the present disclosure. On the laboratory-scale, fully cured twill weave interwoven (carbon and polyethylene) laminate of PECAN (Formulation F1 and HC-7) were submerged in a bath of methanol (with or without other polar solvents such as dichloromethane, acetone, toluene, chloroform, etc.) with between 0.01 wt % and 10 wt % base catalyst (e.g. potassium carbonate and/or other carbonates) and slightly heated to a temperature between 23° C. and 50° C.) for a period of time between 1 hour and 30 days. These mixtures were then filtered and fibers were obtained in a form and quality that could be re-used in subsequent products. On the manufacturing-scale, end-of-life composites may be shredded and the resulting resin and fiber placed in a large vessel filled with methanol and potassium carbonate catalyst. The contents may be stirred for up to 5 days at elevated temperatures to fully depolymerize the resin, with the resulting chopped fibers recovered for second-generation usage.

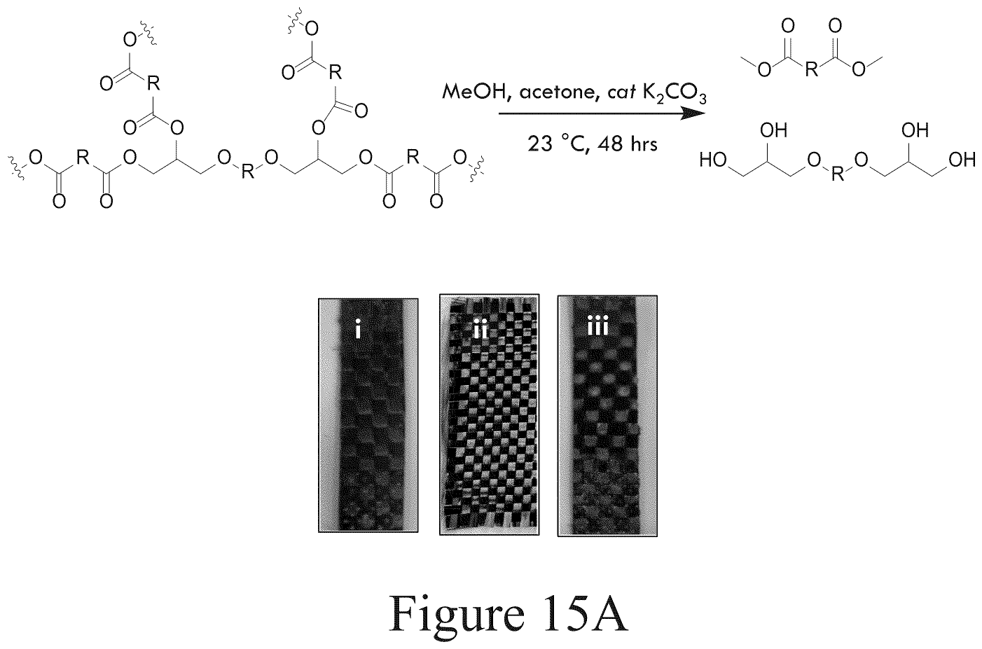

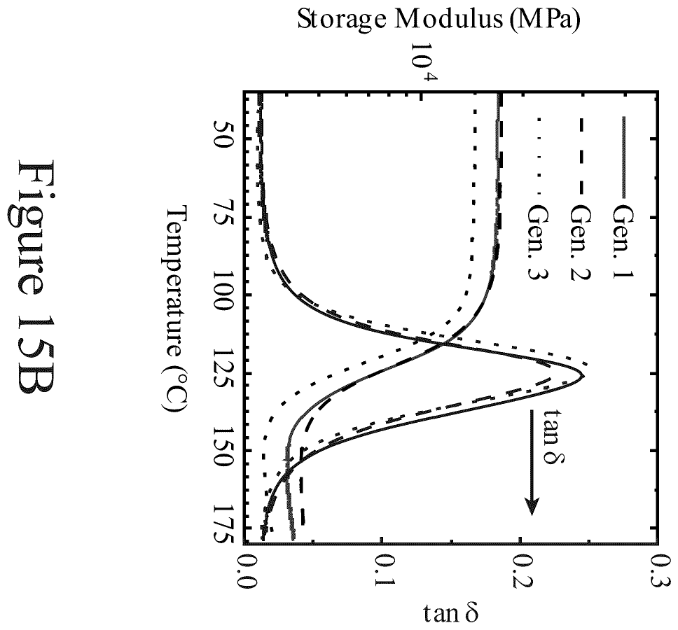

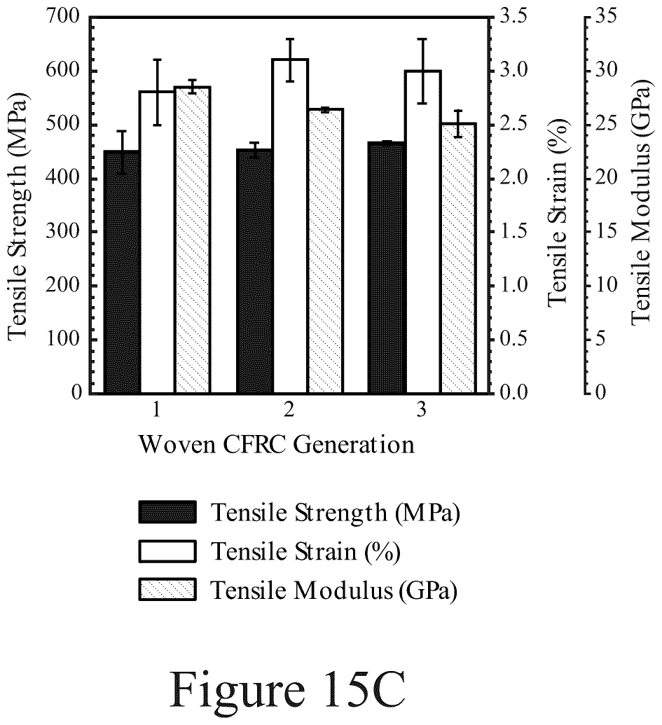

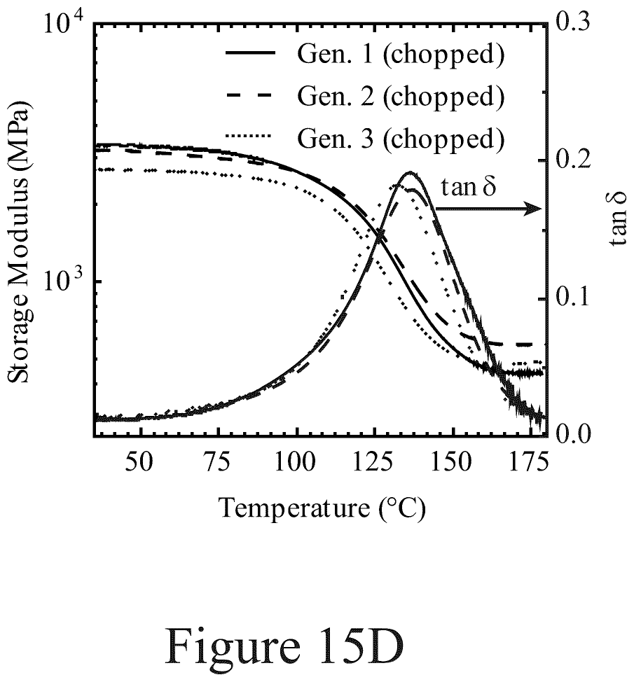

Panel A of FIG. 15A illustrates methanolysis of a polyester thermoset. Panel B of FIG. 15A shows photographs of composites constructed of a three ply, twill weave, carbon-fiber reinforced plies, using the F1 matrix material formulation for the resin on the first-generation in i and ii the recovered fibers after depolymerization. In iii, the composite resulting from re-impregnating the recovered fibers with the F1 matrix material formulation at a 1:1 weight ration of fiber to matrix material. FIG. 15B illustrates DMA temperature sweeps of three generations of carbon fiber reinforced composites through the process of virgin resin impregnation, cure, depolymerization, fiber recovery and wash, and re-impregnation with virgin resin. Notably the storage modulus (black) does not show appreciable loss across three generations, within 13%. The peak tan delta or Tg is retained. Tensile tests on three generations of plain weave carbon fiber reinfirced composites using the F1 matrix material formulation are shown in FIG. 15C, where strength and strain are conserved across three lives. Modulus decreases slightly. As shown in FIG. 15D, three generations of chopped CF (¼″) were fabricated and analyzed and show similar trends to those depicted in FIG. 15B.

### EXAMPLES

Example 1. A composition comprising: a matrix material comprising at least one of a polyester resin, a polyester polymer, or a combination thereof; and a plurality of fibers, wherein: the plurality of fibers comprises a first portion of an inorganic fiber and a second portion of an organic fiber, and the plurality of fibers and the matrix material are in physical contact.

Example 2. The composition of Example 1, wherein the matrix material is derived from reacting an anhydride with an epoxy.

Example 3. The composition of Example 2, wherein the anhydride comprises at least one of methylhexahydrophthalic anhydride (MHHPA), glutaric anhydride (GA), or a combination thereof.

Example 4. The composition of Example 2, wherein the epoxy comprises at least one of 1,4-butanediol-diglycidly ether (BDODGE), sorbitol polyglycidyl ether (SPGE), poly(ethylene glycol) diglycidyl ether (PEGDGE), or a combination thereof.

Example 5. The composition of Example 1, wherein the matrix material comprises a first repeat unit as defined by Structure (I),

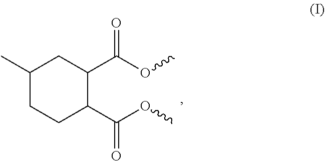

and [symbol] is a covalent bond.

Example 6. The composition of Example 5, wherein the matrix material further comprises a second repeat unit as defined by Structure (II),

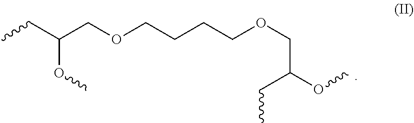

Example 7. The composition of Example 6, wherein the matrix material further comprises a second repeat unit as defined by Structure (III),

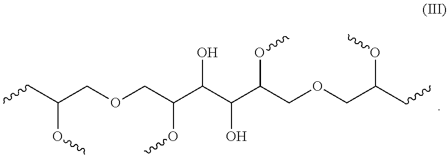

Example 8. The composition of Example 1, wherein the matrix material comprises a structure as defined by Structure (IV),

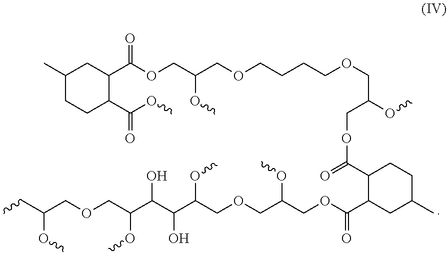

Example 9. The composition of Example 1, wherein the matrix material is a thermoset.

Example 10. The composition of Example 9, wherein the thermoset has a percent elongation between 3.4% and 16.1%.

Example 11. The composition of Example 9, wherein the thermoset has a tensile strength between 2.5 MPa and 66 MPa.

Example 12. The composition of Example 9, wherein the thermoset has a tensile toughness between 21 MJ/m³ and 400 MJ/m³.

Example 13. The composition of Example 1, wherein the inorganic fiber comprises at least one of glass, carbon, basalt, or a combination thereof.

Example 14. The composition of Example 1, wherein the organic fiber comprises at least one of polypropylene (PP), polyethylene (PE), polyethylene terephthalate (PET), polyether ether ketone (PEEK), a polyaramid, polyparaphenylene terephthalamide, or a combination thereof.

Example 15. The composition of Example 1, wherein the fibers are chopped.

Example 16. The composition of Example 1, wherein the fibers are at least one of woven, unidirectional, or a combination thereof.

Example 17. The composition of Example 16, wherein the fibers are woven into at least one of a twill weave, a satin weave, a plain weave, a veil weave, or a combination thereof.

Example 18. The composition of Example 1, wherein the matrix material is present a concentration between 5 wt % and 99.9 wt % relative to the matrix material and the plurality of fibers.

Example 19. The composition of Example 1, where the matrix material and the plurality of fibers are present at a mass ratio of matrix material to fibers of about 1:1.

Example 20. The composition of Example 1, wherein the matrix material and the plurality of fibers are positioned to form an interlaminate hybrid composite comprising a first ply and a second ply.

Example 21. The composition of Example 20, wherein the first ply comprises the first portion of the plurality of fibers and the second ply comprises the second portion of the plurality of fibers.

Example 22. The composition of Example 21, wherein the first portion contains carbon fibers and the second portion contains PE fibers.

Example 23. The composition of Example 21, comprising at least two plies of carbon fibers and two plies of PE fibers.

Example 24. The composition of Example 23, wherein the plies of carbon fibers and the plies of PE fibers are alternating.

Example 25. The composition of Example 1, wherein the matrix material and the plurality of fibers are positioned to form an interwoven hybrid composite comprising a ply.

Example 26. The composition of Example 25, wherein the ply comprises interwoven fibers of the first portion and the second portion of the plurality of fibers.

Example 27. The composition of Example 26, wherein the first portion is at a concentration relative to the plurality of fibers between 1 wt % and 99 wt %.

Example The composition of Example 27, where the first portion contains carbon fibers and the second portion comprises PE fibers.

Example 29. The composition of Example 28, wherein the concentration of the first portion is between 50 wt % and 90 wt %.

Example 30. The composition of Example 25, comprising at least four plies.

Example 31. The composition of Example 1, wherein: the matrix material comprises a polyester thermoset, the first portion and the second portion form a first ply of interwoven organic fibers and inorganic fibers, the first portion forms a second ply of woven inorganic fibers, the organic fibers are constructed of polyethylene, and the inorganic fibers are constructed of carbon fiber.

Example 32. The composition of Example 1, first ply is a twill weave and the second ply is a twill weave.

Example 33. The composition of Example 31, wherein: the first portion comprises between 20 wt % and 40 wt % polyethylene, and the first portion comprises between 60 wt % and 80 wt % carbon fiber.

Example 34. The composition of Example 33, comprising: three plies of the first ply; and two plies of the second ply, wherein: the first plies and the second plies are stacked in an alternating order.

Example 35. The composition of Example 33, further comprising a flexural strength between 245 MPa and 285 MPa.

Example 36. The composition of Example 33, further comprising a flexural strain between 3.5% and 3.9%.

Example 37. The composition of Example 33, further comprising a flexural toughness between 500 MJ/m³ and 660 MJ/m³ MPa.

Example 38. The composition of Example 33, further comprising a flexural modulus between 8.9 GPa and 9.7 GPa.

Example 39. The composition of Example 1, wherein: the matrix material comprises a polyester thermoset, the first portion and the second portion form a ply of interwoven organic fibers and inorganic fibers, the organic fibers are constructed of polyethylene, and the inorganic fibers are constructed of carbon fiber.

Example 40. The composition of Example 39, wherein the ply is a twill weave.

Example 41. The composition of Example 39, comprising five plies.

Example 42. The composition of Example 31, wherein: the first portion comprises between 40 wt % and 60 wt % polyethylene, and the first portion comprises between 40 wt % and 60 wt % carbon fiber.

Example 43. The composition of Example 42, further comprising a flexural strength between 225 MPa and 255 MPa.

Example 44. The composition of Example 42, further comprising a flexural strain between 3.3% and 3.5%.

Example 45. The composition of Example 42, further comprising a flexural toughness between 376 MJ/m³ and 436 MJ/m³ MPa.

Example 46. The composition of Example 42, further comprising a flexural modulus between 7.5 GPa and 9.9 GPa.

Example 47. A method comprising: immersing in methanol a first-generation composite comprising: a matrix material comprising a polyester thermoset; and a plurality of fibers, wherein: the plurality of fibers comprise a first portion of an inorganic fiber and a second portion of an organic fiber, the plurality of fibers and the matrix material are in physical contact, the immersing results in the deconstruction of matrix material and the forming of a mixture comprising a liquid phase and a solid phase, the liquid phase comprises methanol and deconstruction products, and the solid phase comprises at least one of the organic fiber, the inorganic fiber, or a combination thereof.

Example 48. The method of Example 47, further comprising recovering the solid phase from the liquid phase.

Example 49. The method of Example 48, further comprising using at least a portion of the recovered solid phase to construct a second-generation composite.

Example 50. The method of Example 49, wherein the second-generation composite is constructed using a matrix material comprising the polyester thermoset.

As used herein the term “substantially” is used to indicate that exact values are not necessarily attainable. By way of example, one of ordinary skill in the art will understand that in some chemical reactions 100% conversion of a reactant is possible, yet unlikely. Most of a reactant may be converted to a product and conversion of the reactant may asymptotically approach 100% conversion. So, although from a practical perspective 100% of the reactant is converted, from a technical perspective, a small and sometimes difficult to define amount remains. For this example of a chemical reactant, that amount may be relatively easily defined by the detection limits of the instrument used to test for it. However, in many cases, this amount may not be easily defined, hence the use of the term “substantially”. In some embodiments of the present invention, the term “substantially” is defined as approaching a specific numeric value or target to within 20%, 15%, 10%, 5%, or within 1% of the value or target. In further embodiments of the present invention, the term “substantially” is defined as approaching a specific numeric value or target to within 1%, 0.9%, 0.8%, 0.7%, 0.6%, 0.5%, 0.4%, 0.3%, 0.2%, or 0.1% of the value or target.

As used herein, the term “about” is used to indicate that exact values are not necessarily attainable. Therefore, the term “about” is used to indicate this uncertainty limit. In some embodiments of the present invention, the term “about” is used to indicate an uncertainty limit of less than or equal to ±20%, ±15%, ±10%, ±5%, or ±1% of a specific numeric value or target. In some embodiments of the present invention, the term “about” is used to indicate an uncertainty limit of less than or equal to ±1%, ±0.9%, ±0.8%, ±0.7%, ±0.6%, ±0.5%, ±0.4%, ±0.3%, ±0.2%, or ±0.1% of a specific numeric value or target.

The foregoing discussion and examples have been presented for purposes of illustration and description. The foregoing is not intended to limit the aspects, embodiments, or configurations to the form or forms disclosed herein. In the foregoing Detailed Description for example, various features of the aspects, embodiments, or configurations are grouped together in one or more embodiments, configurations, or aspects for the purpose of streamlining the disclosure. The features of the aspects, embodiments, or configurations, may be combined in alternate aspects, embodiments, or configurations other than those discussed above. This method of disclosure is not to be interpreted as reflecting an intention that the aspects, embodiments, or configurations require more features than are expressly recited in each claim. Rather, as the following claims reflect, inventive aspects lie in less than all features of a single foregoing disclosed embodiment, configuration, or aspect. While certain aspects of conventional technology have been discussed to facilitate disclosure of some embodiments of the present invention, the Applicants in no way disclaim these technical aspects, and it is contemplated that the claimed invention may encompass one or more of the conventional technical aspects discussed herein. Thus, the following claims are hereby incorporated into this Detailed Description, with each claim standing on its own as a separate aspect, embodiment, or configuration.

What is claimed is:

1. A composition comprising:
a matrix material comprising at least one of a polyester resin, a polyester polymer, or a combination thereof; and
a plurality of fibers, wherein:
the plurality of fibers comprise a first portion of an inorganic fiber and a second portion of an organic fiber, and
the plurality of fibers and the matrix material are in physical contact.

2. The composition of claim 1, wherein the matrix material is derived from reacting an anhydride with an epoxy.

3. The composition of claim 2, wherein the anhydride comprises at least one of methylhexahydrophthalic anhydride (MHHPA), glutaric anhydride (GA), or a combination thereof.

4. The composition of claim 2, wherein the epoxy comprises at least one of 1,4-butanediol-diglycidly ether (BDODGE), sorbitol polyglycidyl ether (SPGE), poly(ethylene glycol) diglycidyl ether (PEGDGE), or a combination thereof.

5. The composition of claim 1, wherein the matrix material is a thermoset.

6. The composition of claim 1, wherein the inorganic fiber comprises at least one of glass, carbon, basalt, or a combination thereof.

7. The composition of claim 1, wherein the organic fiber comprises at least one of polypropylene (PP), polyethylene (PE), polyethylene terephthalate (PET), polyether ether ketone (PEEK), a polyaramid, polyparaphenylene terephthalamide, or a combination thereof.

8. The composition of claim 1, wherein the fibers are chopped.

9. The composition of claim 1, wherein the fibers are at least one of woven, unidirectional, or a combination thereof.

10. The composition of claim 1, wherein the matrix material and the plurality of fibers are positioned to form an interlaminate hybrid composite comprising a first ply and a second ply.

11. The composition of claim 10, wherein the first ply comprises the first portion of the plurality of fibers and the second ply comprises the second portion of the plurality of fibers.

12. The composition of claim 11, wherein the first portion contains carbon fibers and the second portion contains PE fibers.

13. The composition of claim 11, comprising at least two plies of carbon fibers and two plies of PE fibers.

14. The composition of claim 13, wherein the plies of carbon fibers and the plies of PE fibers are alternating.

15. The composition of claim 1, wherein the matrix material and the plurality of fibers are positioned to form an interwoven hybrid composite comprising a ply.

16. The composition of claim 15, wherein the ply comprises interwoven fibers of the first portion and the second portion of the plurality of fibers.

17. The composition of claim 16, where the first portion contains carbon fibers and the second portion comprises PE fibers.

18. The composition of claim 1, wherein:
the matrix material comprises a polyester thermoset,
the first portion and the second portion form a first ply of interwoven organic fibers and inorganic fibers,
the first portion forms a second ply of woven inorganic fibers,
the organic fibers are constructed of polyethylene, and
the inorganic fibers are constructed of carbon fiber.

19. The composition of claim 1, wherein:
the matrix material comprises a polyester thermoset,
the first portion and the second portion form a ply of interwoven organic fibers and inorganic fibers,
the organic fibers are constructed of polyethylene, and
the inorganic fibers are constructed of carbon fiber.

20. A method comprising:
immersing in methanol a first generation composite comprising:
a matrix material comprising a polyester thermoset; and
a plurality of fibers, wherein:
the plurality of fibers comprise a first portion of an inorganic fiber and a second portion of an organic fiber,
the plurality of fibers and the matrix material are in physical contact,
the immersing results in the deconstruction of matrix material and the forming of a mixture comprising a liquid phase and a solid phase,
the liquid phase comprises methanol and deconstruction products,
and the solid phase comprises at least one of the organic fiber, the inorganic fiber, or a combination thereof.
